(19) United States
(12) Patent Application Publication
(10) Pub. No.: US 2017/0237601 A1
(43) Pub. Date: Aug. 17, 2017

(54) Network Management

(71) Applicant: HANGZHOU H3C TECHNOLOGIES CO., LTD., Zhejiang (CN)

(72) Inventors: Guoping ZHU, Beijing (CN); Ju WANG, Beijing (CN)

(21) Appl. No.: 15/502,090

(22) PCT Filed: Aug. 3, 2015
(86) PCT No.: PCT/CN2015/085948

§ 371 Date: Feb. 6, 2017

(30) Foreign Application Priority Data
Aug. 4, 2014 (CN) 201410380335.0

(51) Int. Cl. H04L 12/24; H04L 29/06; H04L 29/08; H04L 12/46; H04L 29/12

(52) U.S. Cl. CPC H04L 41/0213; H04L 12/4633; H04L 61/2015; H04L 67/2895; H04L 63/0281; H04L 63/029; H04L 63/0272

(57) ABSTRACT

A proxy server sets up a tunnel with a managed object in a private network and allocates management information for the managed object. The management information comprises a management address of the managed object. The proxy server receives a network management message with a destination address being the management address of the managed object. The proxy server forwards the network management message to the managed object over the tunnel and forwards a network management message, from the tunnel, with a source address being the management address of the managed object to a Network Management System (NMS).

### BACKGROUND

Cloud computing is developing rapidly. A cloud may provide a pool of resources and may have a very large capacity, so that people can be served from the pool of resources as needed and pay for their use of resources or services. For example, a device manufacturer may sell network devices (e.g., a router, a switch, an Access Point (AP), etc.) to a user, so that the user builds her or his private network using these network devices. Meanwhile a network management service provider (e.g., a device manufacturer) provides the user purchasing the network devices with a management service for managing the network devices of the User. For example, a Network Management System (NMS) deployed in the cloud can manage the network devices of the user remotely from the cloud.

### BRIEF DESCRIPTION OF THE DRAWINGS

FIG. 1 illustrates a network deployment structural diagram of network management in a cloud in an example;

FIG. 2 illustrates a schematic hardware architecture diagram of a device where a proxy server resides, and a device where a managed object resides in an example;

FIG. 3 illustrates a flow chart of a network management method on a proxy server in an example;

FIG. 4 illustrates a flow chart of a network management method on a managed object in an example;

FIG. 5 illustrates a schematic flow chart of network management on a switch 122 in FIG. 1; and

FIG. 6 illustrates a schematic network structural diagram after the switch 122 in FIG. 1 is managed.

### DETAILED DESCRIPTION OF THE EMBODIMENTS

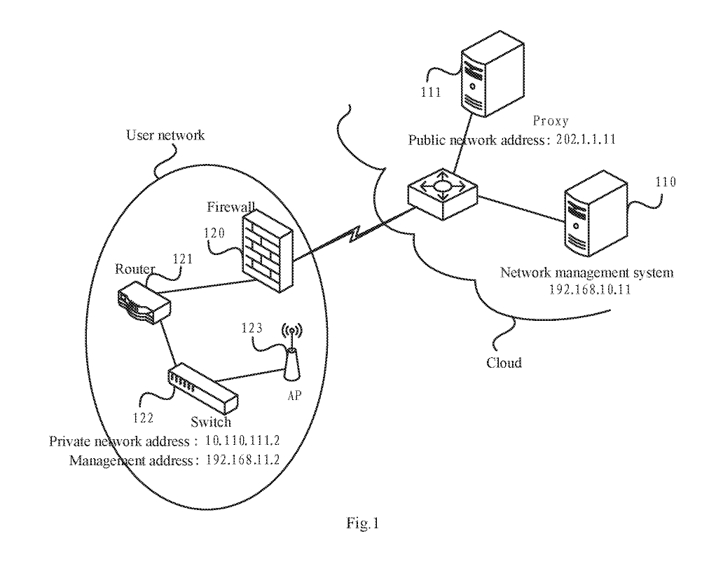

FIG. 1 illustrates a network structure to which network management of this disclosure is applied, where the network can include a user network (referred to as a private network) and a cloud (referred to as a public network). Particularly the user network can include a firewall 120, a router 121, a switch 122 and an access point (AP) 123. The cloud may include a network management system (NMS) 110, and in the example of this disclosure, a proxy server 111 is further deployed in the cloud network as illustrated in FIG. 1.

As illustrated in FIG. 3, the switch 122 and the AP 123 in the user network access an external network (e.g., the cloud network) through the router 121. A firewall 120 can be deployed between the router 121 and the external network to perform message filter and Network Address Translation (NAT) to thereby secure the user private network. When the NMS 110 deployed in the cloud provides a network management service for the user network, any, some or all of the router 121, the switch 122 and the AP 123 of the user network may be considered as “managed objects”.

The network management protocol used by the network management system may for example be a widely deployed network management protocol such as, e.g., the Telnet, the Simple Network Management Protocol (SNMP), the Network Configuration Protocol (Netconf), etc. However, with this setup, the firewall 120 may block the NMS from connecting to the managed objects. For example, the firewall may block the NMS from initiating on its own initiative a connection to a managed object in the user private network, due to the configuration of the firewall. The firewall may, for instance, be configured to block an NMS from initiating an unprompted connection to a managed option by one of the commonly used network management protocols listed above. The present disclosure proposes various network management techniques by which a NMS may traverse the user network to manage objects in the user network. In some examples the NMS may use network protocols such as Telnet, SNMP, Netconf etc. Further referring to FIG. 1, the proxy 111 and the managed object can cooperate with a network management control logic to enable the NMS to traverse the firewall to thereby initiate an access to the managed object in the private network without any limitation on the network management protocol applied by the NMS and without any constraint on the configuration of the firewall.

In FIG. 1, the proxy server in the cloud can be a separate physical device, e.g., a server or a network device; or can be a virtual device including several physical devices, e.g., a pool of proxy server consisted of several servers or network devices and load sharing devices; or can be a functional module operating on an existing physical device or virtual device in the network, e.g., a functional module operating on the NMS. The managed object in the user network can be a physical device, e.g., a server or a network device; or can be a logic device, e.g., a virtual machine, a virtual switch, a cluster of servers, or a system in which network devices are stacked.

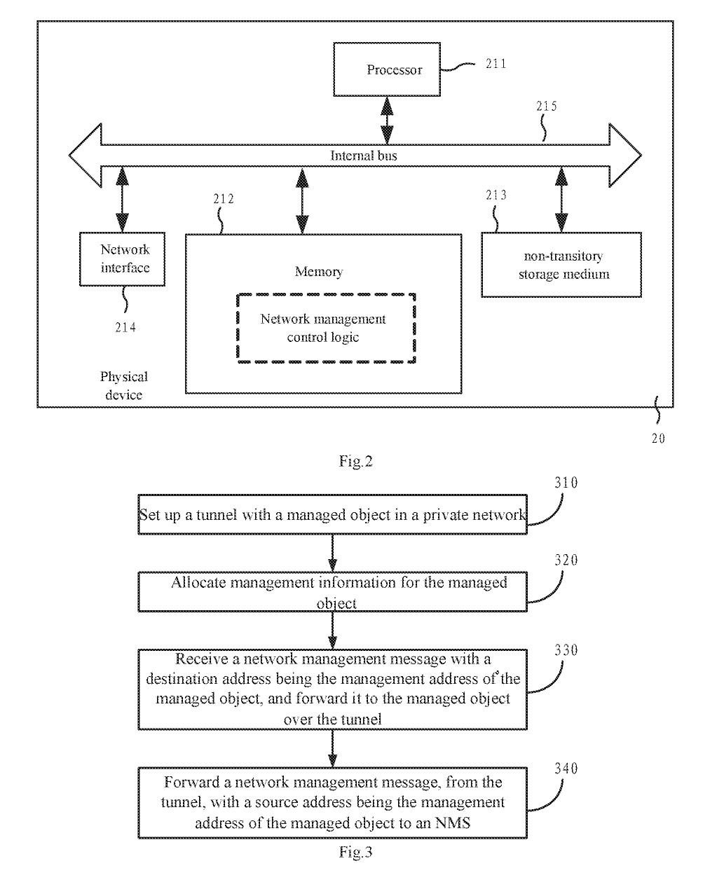

Referring to FIG. 2, either a physical device where the proxy server resides or a physical device where the managed object resides can be embodied in the hardware structure as illustrated in FIG. 2. The physical device 20 can include a processor 211 such as a central processing unit (CPU), a memory 212, a non-transitory storage medium 213, such as a memory, optical or magnetic drive etc, and a network interface 214, all of which are connected with each other by an internal bus 215. In this example, The non-transitory storage medium may store machine readable instructions that are executable by the processor to perform a network management control logic, where in the physical device where the proxy server resides, the processor 211 can read the network management control logic of the proxy server, and in the physical device where the managed object resides, the processor 211 can read the network management control logic of the managed object.

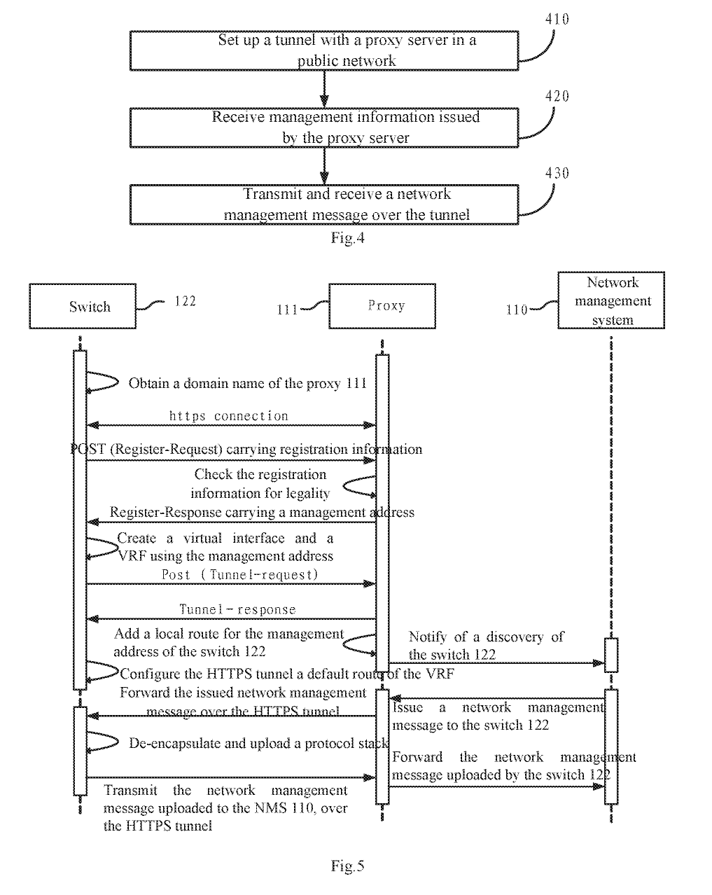

FIG. 3 and FIG. 4 illustrate network management flows performed by the proxy server and the managed object in cooperation by running the network management control logic above, where FIG. 3 illustrates a process performed by the proxy server, and FIG. 4 illustrates a process performed by the managed object.

In 310 and 410, a tunnel is set up between the proxy server in the public network and the managed object in the private network,

The managed object can be provided with an address of the proxy server in the public network in a number of approaches, for example, a domain name of the proxy server can be written into the non-transitory storage medium as a preset configuration parameter before the device where the managed object resides is shipped from a factory; or the domain name or the public network address of the proxy server in the public network can be issued by a Dynamic Host Configuration Protocol (DHCP) server to the managed object as a configuration parameter.

The managed object which can initiate setting up a tunnel with the proxy server as a client in the Client/Server (C/S) mode using the domain name or the public network address of the proxy server. The managed object can set up the tunnel in various protocols supporting the C/S mode (that is, the managed object which is a client can initiate communication to the proxy server in the protocol), e.g., the Hyper Text Transfer Protocol (HTTP), the Hyper Text Transfer Protocol over Secure Socket Layer (HTTPS), the Session Initiation Protocol (SIP), the UDP and various mail protocols, etc. A node in the private network frequently applies these protocols and ports thereof and typically will not be blocked by the firewall; and even if some protocol is blocked by the firewall, the node can set up a tunnel in another protocol which is not blocked by the firewall.

A tunnel provides a message encapsulation approach to encapsulate an original message (with a header including an address of a sender and an address of a destination) as a data payload into another message (referred to as a message after encapsulation) for transmission. The address of the sender and the address of the destination in the original message are referred to as internal addresses, and addresses in the message after encapsulation are referred to as external addresses including a source address and a destination address which are typically addresses used by the nodes on two ends of the tunnel in setting up the tunnel.

With the tunnel, a message in one protocol can be encapsulated into another protocol, or the internal addresses can be encapsulated into the external addresses, so that the message can be transmitted to the opposite end of the tunnel in the protocol after encapsulation and/or the external addresses. The message arriving at the opposite end of the tunnel is de-encapsulated into the original message with the addresses which are still the internal addresses.

In this example, the tunnel can be set up in one of the various existing protocols supporting transmission over a tunnel or in a customized communication mode supporting transmission over a tunnel.

After the tunnel is set up, the proxy server can allocate management information for the managed object, that is, the proxy server can issue the management information to the managed object, as represented in 320 and 420.

For example, the management information which is allocated by the proxy server for the managed object, including a management address of the managed object, e.g., an IP address, a subnet mask, a gateway or other address information. The managed object communicates with the NMS in the cloud using the allocated management address, so the management address is a network address accessible to the NMS, for example, a network segment where the IP address allocated for the managed object lies can be reserved, lie in the same network as the NMS, and be reachable over a route. Additionally the proxy server can further configure the managed object with other pre-configuration information required for network management dependent upon a particular service demand.

It shall be noted that the blocks 310 and 320, and the blocks 410 and 420 can be performed in a number of timing orders including but not limited to the following scenarios:

Firstly after the tunnel is set up between the managed object and the proxy server, the proxy server further issues the management information allocated for the managed object over the tunnel. In this scenario, the block 310 and the block 410 are performed respectively before the block 320 and the block 420.

Secondly the managed object initiates a connection to the proxy server, and the proxy server issues the management information allocated for the managed object to the managed object over the setup connection; and the managed object switches the setup connection to a tunnel mode upon reception of the management information. In this scenario, the tunnel will not have been set up between the managed object and the proxy server until the initiated connection is switched to the tunnel mode. In other words, the block 320 and the block 420 are performed respectively while the block 310 and the block 410 are being performed.

In an application scenario, the proxy server can firstly check the managed object for legality before issuing the management information for the managed object. In this scenario, the managed object transmits registration information to the proxy server; and the proxy server receives the registration information of the managed object, and inquires a preset database to check the registration information of the managed object for legality, and if the registration information of the managed object is present in the database, then the proxy server can determine the legality check is passed, and allocate the management information for the managed object. If the managed object fails to pass the legality check, then the proxy server breaks down the communication link to the managed object. The registration information can include a device ID and a host name of the device where the managed object resides, an IP address of the managed object in the private network, and other information related to the managed object and the device where the managed object resides.

For example, a tenant of a network management cloud service subscribes to the management service for N network devices, and submits registration information of the N network devices for which the management services will be applied, in an online device database accessible over the public network, where the registration information includes devices IDs, host names, the tenant, etc. After these network devices get online, they initiates connections to the proxy server and transmit their own registration information to the proxy server. The proxy server checks the device IDs, the host names, the tenant, etc., transmitted by the network devices for consistency with the online device database, and if they are consistent, then the proxy server determines that the legality check is passed, and provides them with the network management service. In this example, a pool of IP addresses allocated for the managed objects can be reserved on the proxy server dependent upon the number of management devices of the tenant to be managed to thereby reserve the differently sized pool of IP addresses for the tenant; or a large pool of addresses can be shared by a plurality of tenants, dependent upon how the deployed network is shared between the NMS and the tenants.

In order to enhance the security, to prevent another network device from abusing the legal managed objects, a key or a certificate can be added to the registration information uploaded by the managed object for security authentication in the legality check. In this example, the disclosure will not be limited to any particular security authentication technology in use, e.g., shared key based Pack authentication and Check authentication, certificate based Secure Socket Layer (SSL) authentication, etc.

After the tunnel is set up and the management information is allocated for the managed object, the proxy server and the managed object can transmit and receive a network management message using the management information over the tunnel, where the network management message includes the address of the managed object, which is the management address in the management information.

For example, in 430, the managed object can be configured locally with the management address issued by the proxy server to perform a network management function using the management address, where the network management message includes the local end address which is the management address, and the opposite end address which is typically the address of the NMS. The managed object transmits and receives the network management message with the proxy server over the tunnel, where the network management message which is the original message is encapsulated at the entrance to the tunnel, and a source address and a destination address of the message after encapsulation are the addresses used by the managed object and the proxy server in setting up the tunnel (e.g., the address of the managed object in the private network, and the address of the proxy server in the public network). The protocol of the message after encapsulation is the protocol used in setting up the tunnel, so that the message after encapsulated can traverse the firewall (otherwise, the tunnel may fail to be set up). The message arriving at the exit of the tunnel is de-encapsulated into the network management message forwarded by the proxy server in the cloud. Since the network management message includes the management address of the managed object, there is equivalently a node with the management address, connected in the cloud network from the perspective of another node (e.g., the NMS), so the various existing network management protocols can be applied directly without being modified anyway.

In an example, the managed object creates a virtual interface, configures the virtual interface with the management address issued by the proxy server, and transmits and receives the network management message via the virtual interface. If the private network where the managed object resides, and the management network where the NMS in the cloud resides may overlap in IP address, then a Virtual Private Network Routing and Forwarding Instance (VRF) can be created for the virtual interface with the management address, and the network management message can be transmitted and received between the created VRF and the proxy server over the tunnel, so that the VRF can enable a plurality of Virtual Private Networks (VPNs) to access the same space of addresses to thereby address the problem of confliction in address between the private network and the cloud.

In 330, the proxy server can forward the network management message with the destination address being the management address of the managed object, to the managed object over the tunnel upon reception of the message. In an example, the proxy server can add a local route with the setup tunnel being a next-hop outgoing interface of the management address of the managed object. The network management message transmitted to the managed object at the opposite end of the tunnel is transmitted to the managed object over the tunnel according to the local route. The proxy server can add the local route after allocating the management address for the managed object or can add the local route after both allocating the management address and setting up the tunnel.

In 340, the proxy server can forward to the NMS the network management message, from the setup tunnel, with the source address being the management address of the managed object. That is, the proxy server forwards the network management message between the NMS and the managed object with the management address over the setup tunnel.

The blocks 330 and 340 may not be performed in any particular timing order.

It shall be noted that the proxy server and the NMS may operate on different servers (physical servers or virtual servers), or the proxy server can operate as a functional module on the NMS. If the proxy server operates as a functional module on the NMS, then the network management message with the destination address being the management address of the managed object can be received in the block 330 in this example by receiving the network management message transmitted by the functional module which is the NMS in the same server; and the network management message can be forwarded to the NMS in the block 340 by forwarding the network management message to the functional module which is the NMS in the same server.

If the proxy server operates as a functional module on the NMS, then the NMS will discover the managed object after setting up the tunnel with the managed object. Thereafter the message transmitted by the NMS to the managed object can traverse the firewall over the setup tunnel to arrive at the managed object; and the managed object with the management address can receive and transmit the message with the NMS over the setup tunnel, so that the managed object can be managed by the NMS.

If the proxy server and the NMS reside on different devices, then the managed object can be discovered by the NMS in the following several approaches:

Firstly the NMS initiates a device discovery process directly to the managed object. For example, the NMS can execute a ping (packet detection) command to traverse some specific network segment for a new managed object in the network segment. Upon reception of the ping command for the management address of the managed object on the opposite end of the tunnel, the proxy server performs the block 330 to encapsulate the ping command and then forward it to the managed object over the tunnel; and a response of the managed object to the ping command arrives at the proxy server over the tunnel and is further forwarded by the proxy server to the NMS, so that the device of the managed object is discovered.

Secondly the proxy server can notify the NMS of a discovery of the managed object, and notify the NMS of the management information of the managed object, after allocating the management information for the managed object.

Thirdly the proxy server records the management information allocated for the managed object after allocating the management information for the managed object; and the NMS can discover the new managed object by retrieving the entry of the proxy server.

The NMS will transmit the network management message with the management address being the address of the managed object after discovering the managed object; and the network management message will be routed to the proxy server in the cloud, and the proxy server will encapsulate the entire network management message into the tunnel and transmit it to the managed object. The network management message transmitted by the managed object to the NMS is encapsulated and transmitted to the proxy server over the tunnel, de-encapsulated by the proxy server, and then forwarded to the NMS in the cloud according to the route.

Thus a virtual mirror with a management address accessible to the NMS is equivalently created by the proxy server for each managed object in the private network, in the management network of the cloud; and all the network management functions can be performed with the management address, so that the various existing network management protocols can be applied directly without being modified anyway and without any constraint on the configuration of the firewall of the private network.

How the NMS 110 traverses the firewall 120 through the proxy 111 to perform network management on the switch 122 will be described below taking as an example the switch 122 in the private network in the network illustrated in FIG. 1, where reference can be made to FIG. 5 for a particular flow thereof:

1) The switch 122 retrieves a factory configuration to obtain the domain name of the proxy 111: nms-proxy.h3c.com,

2) The switch 122 initiates an HTTPS connection to the domain name of the proxy 111 (with the IP address of 202.1.1.11 in the public network). The HTTPS connection can be set up between the switch 122 and the proxy 111 due to the inherent security of the HTTPS, and its capability to traverse the NAT and the firewall.

The switch 122 initiates a connection to the address 202.1.1.11 of the proxy 111 in the public network using its IP address of 10.110.111.2 in the private network, where the switch 122 transmits a message with a source IP address of 10.110.111.2 and a destination IP address of 202.1.1.11 to the proxy 111 through the NAT and the firewall.

3) The switch 122 transmits an HTTP POST command to the proxy 111 over the setup connection to make a Register-Request by uploading its registration information including a device ID of 0002343457456735673567, a host name of Switch, and the IP address of 10.110.111.2 in the private network.

The Register-Request message can be in the following format:

POST /Register.cgi HTTP/1.1
Host: nms-proxy.h3c.com
Content-Length: 100
<data>

<deviceID>0002343457456735673567</ deviceID >

<hostname>switch</username>

<ip>10.110.111.2</ip>
...

</data>

4) The proxy 111 receives and stores the registration information of the switch 122. into a database of managed objects. The proxy 111 inquires about device registration information submitted by the tenant and compares it with the registration information uploaded by the switch 122 to check the switch 122 for legality.

5) The proxy 111 allocates management information for the switch 122 passing the check, over the setup connection and responds to the switch 122 with a Register-Response carrying the management information allocated by the proxy 111, including a management address of 192.168.11.2, a subnet mask 24, and a default route of 192.168.11.254. The IP address of the NMS is 192.168.10.11, which is reachable in the cloud over the route together with the network segment where the management address of the switch 122 lies.

The Register-Response message can be in the following format:

HTTP/1.1 200 OK
Date: Mon, 9 Apr 2014 09:20:42
Content-Type: text/xml
Content-Length: 300
<data>

<IP>192.168.11.2</IP>
<mask>24</mask>
<gateway>192.168.11.254</gateway>
...

</data>

6) The switch 122 sets up a virtual interface, and adds the issued management address to the virtual interface, and also creates a separate VRF for this virtual interface, upon reception of the management information. Thereafter the switch 122 transmits and receives a network management message through the created VRF.

7) The switch 122 transmits again an HTTP POST command to the proxy 111 over the setup connection to make a Tunnel-Request for switching the connection with the proxy 111 to an HTTPS tunnel.

The Tunnel-Request message can be in the following format:

POST/Tunnel.cgi HTTP/1.1

Host: nms-proxv.h3c.com

Content-Length: 0

8) The proxy 111 responds to the switch 122 with a Tunnel-Response to allow the HTTPS tunnel to be set up; and the switch 122 sets up the HTTPS tunnel upon reception of a success response of the NMS.

The Tunnel-Response message can be in the following format

HTTP/1.1 200 OK

Date: Mon, 9 Apr 2014 09:20:42

Content-Type: text/xml

Content-Length: 0

9) The proxy 111 adds a local route directed to the management address issued to the switch 122, where the next-hop outgoing interface is the setup HTTPS tunnel.

10) The switch 122 configures the HTTPS tunnel as a default route of the created VRF.

11) The proxy 11 notifies the NMS of the discovery of the new device and transmits the management information of the switch 122 to the NMS 110.

12) If the NMS 110 has a network management message to be transmitted to the switch 122, e.g., PING, SNMP, etc., then the destination IP address will be the management address of 192.168.11.2 allocated by the proxy 111 to the switch 122. The network management message with the destination address of 192.168.11.2 is routed to the proxy 111.

13) The proxy 111 encapsulates the entire network management message transmitted by the NMS 110 to the switch 122 into the HTTPS tunnel to be forwarded to the switch 122 over the local route.

14) The switch 122 receives the encapsulated message over the HTTPS tunnel, parses it for the network management message, and then uploads the network management message to a protocol stack, thus performing the network management function.

15) If the switch 122 has a network management message to be transmitted to the NMS 110, then the network management message is encapsulated into the HTTPS tunnel and transmitted to the proxy 111 due to the default route of the TRF.

16) The proxy receives the encapsulated message from the switch 122 over the HTTPS tunnel, parses it for the network management message, and then transmits the network management message to the NMS 110 over the route.

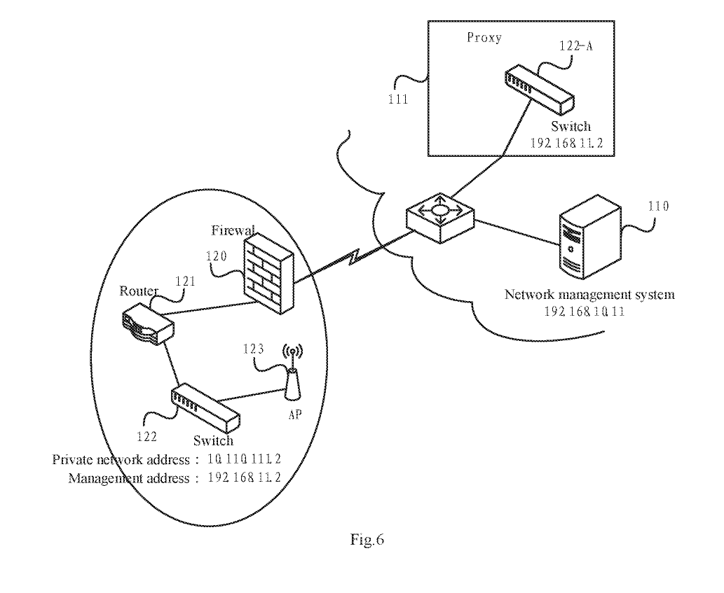

With the flow above, such a management mirror is equivalently is created in the cloud for the switch 122 that is connected with the port of the proxy 111 over the cloud network using the management address of 192.168.11.2 for an access to the switch 122-A in the cloud network, as illustrated in FIG. 6.

If the functions above are embodied in the form of software functional elements and sold or used as a separate product, then the product can be stored in a computer readable storage medium. Based upon such understanding, the technical solution of the disclosure in essence or the part thereof contributing to the prior art or a part of the technical solution can be embodied in the form of a software product stored in a storage medium and including several instructions to cause a computer device (e.g., a personal computer, a server, a network device, etc.) to perform all or a part of the blocks in the methods according to the respective embodiments of the disclosure. The storage medium above can include a U-disk, a mobile hard disk, a Read-Only Memory (ROM), a Random Access Memory (RAM), a magnetic disk, an optical disk or various other medium in which program codes can be stored.

The foregoing disclosure is merely illustrative of preferred embodiments of the disclosure but not o intended to limit the disclosure, and any modifications, equivalent substitutions, adaptations, thereof made without departing from the spirit and scope of the disclosure shall be encompassed in the claimed scope of the appended claims.

1. A network management method comprising:
setting up, by a proxy server, a tunnel between the proxy server in a public network and a managed object in a private network;
allocating, by the proxy server, management information for the managed object, wherein the management information comprises a management address of the managed object;
receiving, by the proxy server, a network management message with a destination address being the management address of the managed object, and forwarding the network management message to the managed object over the tunnel; and
forwarding, by the proxy server, a network management message, from the tunnel, with a source address being the management address of the managed object to a Network Management System (NMS).

2. The method according to claim 1, further comprising:
the proxy server notifying the NMS of a discovery of the managed object and the management information of the managed object; or
the proxy server recording the management information of the managed object for retrieval by the NMS.

3. The method according to claim 1, further comprising:
receiving, by the proxy server, registration information transmitted by the managed object; and
checking, by the proxy server, the managed object for legality against the registration information;
wherein said allocating management information for the managed object comprises allocating the management information for the managed object passing the legality check.

4. The method according to claim 1, further comprising:
adding a local route with a next-hop outgoing interface of the management address being the tunnel.

5. The method according to claim 1, wherein said setting-up a tunnel is initiated by the managed object as a client in a Client/Server (CS) mode.

6. A network management method, applicable to a managed object in a private network, the method comprising:
setting up, by the managed object, a tunnel between the managed object in the private network and a proxy server in a public network;
receiving, by the managed object, management information issued by the proxy server, wherein the management information comprises a management address; and
transmitting and receiving, by the managed object, a network management message over the tunnel, wherein the network management message comprises the management address which is an address of the managed object.

7. The method according to claim 6, wherein said setting up a tunnel with a proxy server in the public network comprising:
the managed object obtaining a domain name of the proxy server from a preset configuration parameter or a configuration parameter allocated by a Dynamic Host Configuration Protocol (DHCP); and
the managed object operating as a client to initiate the setting-up of the tunnel with the domain name in a Client/Server (CS) mode.

8. The method according to claim 6, wherein said transmitting and receiving a network management message over the tunnel comprising:
creating, by the managed object, a virtual interface with the management address, and creating a Virtual Private Network Routing and Forwarding Instance (VRF) for the virtual interface; and
transmitting and receiving, by the managed object, the network management message between the created VRF and the proxy server over the tunnel.

9. A proxy server, comprising a processor, and a non-transitory storage medium, the non-transitory storage medium is to store machine readable instructions that are executable by the processer to perform:
setting up a tunnel with a managed object in a private network;
allocating management information for the managed object, wherein the management information comprises a management address of the managed object;
receiving a network management message with a destination address being the management address of the managed object, and forwarding the network management message to the managed object over the tunnel; and
forwarding a network management message, from the tunnel, with a source address being the management address of the managed object to a Network Management System (NMS).

10. The proxy server according to claim 9, wherein the non-transitory storage medium is further to store machine readable instructions that are executable by the processer to perform:
notifying the NMS of a discovery of the managed object and the management information of the managed object; or
recording the management information of the managed object for retrieval by the NMS.

11. The proxy server according to claim 9, wherein the non-transitory storage medium is further to store machine readable instructions that are executable by the processer to perform:
receiving registration information transmitted by the managed object;
checking the managed object for legality against the registration information;
wherein said allocating management information for the managed object comprises allocating the management information for the managed object passing the legality check.

12. The proxy server according to claim 9, wherein the non-transitory storage medium is further to store machine readable instructions that are executable by the processer to perform:
adding a local route with a next-hop outgoing interface of the management address being the tunnel.

13. A network device, comprising a processor, and a non-transitory storage medium, the non-transitory storage medium is to store machine readable instructions that are executable by the processer to perform:
setting up a tunnel with a proxy server in a public network;
receiving management information issued by the proxy server, wherein the management information comprises a management address; and
transmitting and receiving a network management message over the tunnel, wherein the network management message comprises the management address which is an address of the managed object.

14. The network device according to claim 13, wherein, for said setting up a tunnel with a proxy server in the public network, the non-transitory storage medium is further to store machine readable instructions that are executable by the processer to perform:
obtaining a domain name of the proxy server from a preset configuration parameter or a configuration parameter allocated by a Dynamic Host Configuration Protocol (DHCP); and
operating as a client to initiate the setting-up of the tunnel with the domain name in a Client/Server (CS) mode.

15. The network device according to claim 13, wherein, for said transmitting and receiving a network management message over the tunnel, the non-transitory storage medium is further to store machine readable instructions that are executable by the processer to perform:
creating a virtual interface with the management address, and to create a Virtual Private Network Routing and Forwarding Instance (VRF) for the virtual interface; and
transmitting and receiving the network management message between the created VRF and the proxy server over the tunnel.
